(19) United States
(12) Patent Application Publication
(10) Pub. No.: US 2015/0331863 A1
(43) Pub. Date: Nov. 19, 2015

(54) SELECTION METHOD, METHOD FOR MAINTAINING DATA LIST AND ELECTRONIC DEVICE

(71) Applicant: HTC Corporation, Taoyuan County (TW)

(72) Inventor: Yih-Feng Kao, Taoyuan County (TW)

(73) Assignee: HTC Corporation, Taoyuan County (TW)

(21) Appl. No.: 14/275,900

(22) Filed: May 13, 2014

(51) Int. Cl. G06F 17/30; G06N 5/04

(52) U.S. Cl. CPC G06F 17/30053; G06N 5/048

(57) ABSTRACT

The invention is directed to a method for selecting at least one of a plurality of multimedia data into a preference data list. In the method, a user behavior for respectively reading each of the multimedia data is evaluated. At least one of the multimedia data is selected into the preference data list according to the user behaviors respectively corresponding to the multimedia data.

### BACKGROUND OF THE INVENTION

1. Field of Invention

The present invention relates to a method for processing multimedia data and an electronic device. More particularly, the present invention relates to a method for maintaining a data list according to a user behavior for reading the multimedia data in the data list.

2. Description of Related Art

In human daily life, the electronic devices are widely used to store a lot of multimedia data and to read all kinds of multimedia data from the storage device in the electronic device. As for the music files such as songs, normally, the user manually creates a preference list, selects preference songs into the preference list and uses the electronic device to plays the songs in the preference list. However, with time passing by, the preference list is still unchanged even the music taste of the user has been already changed. Therefore, the user needs to review the songs in the preference list and manually removes songs from or adds songs into the preference list.

The similar things happen on reading multimedia data such as video files, image files or browsing web front-pages. The user always need to manually picks preference multimedia data from huge amount of data into the preference list and occasionally updates the preference list. Otherwise, the preference list becomes outdated and is not so entertaining for the user in comparison with the user's current status.

### SUMMARY OF THE INVENTION

The present invention is to provide a selection method, a method for maintaining a data list and an electronic device capable of automatically providing the user a most satisfaction entertainment in reading the multimedia data according to the data, list which is maintained according to the user behavior.

The present invention provides a method for selecting at least one of a plurality of multimedia data into a preference data list. In the method, a user behavior for respectively reading each of the multimedia data is evaluated. At least one of the multimedia data is selected into the preference data list according to the user behaviors respectively corresponding to the multimedia data.

According to one embodiment of the present invention, the step of selecting at least one of the multimedia data into the preference data list comprises: giving a preference weight to each of the multimedia data according to the user behaviors respectively corresponding to the multimedia data and selecting at least one of the multimedia data into the preference data list, wherein the preference weight of each of the selected multimedia data in the preference data list goes beyond a preference threshold.

According to one embodiment of the present invention, the method further comprises sorting the selected multimedia data in the preference data list according to the given preference weights respectively corresponding to the selected multimedia data.

According to one embodiment of the present invention, the step of evaluating the user behavior for respectively reading each of the multimedia data comprises: evaluating the user behavior respectively corresponding to each of the multimedia data in a regular time schedule.

According to one embodiment of the present invention, the multimedia data include audio files, video files, image files or web front-pages.

According to one embodiment of the present invention, the user behavior corresponding to the multimedia data includes a frequency of repeatedly reading through the corresponding multimedia data, a frequency of completely reading through the corresponding multimedia data, a searching action for searching information of the corresponding multimedia data in the internet, a frequency of skipping the corresponding multimedia data or a frequency of interrupting reading the corresponding multimedia data.

The invention further provides a method for maintaining a data list listing a plurality of preference data selected from a plurality of multimedia data in a database. In the method, a user behavior for respectively reading each of the multimedia data in the database is evaluated. The data list is changed by newly adding one of the multimedia data other than the preference data listed in the data list into the data list when the user behavior corresponding to the newly added multimedia data goes beyond or equals to a preference threshold and removing one of the preference data from the data list when the user behavior corresponding to the removed preference data goes behind the preference threshold.

According to one embodiment of the present invention, the step of changing the data list comprises: giving a preference weight to each of the multimedia data according to the user behaviors respectively corresponding to the multimedia data, determining whether the preference weight of each of the multimedia data goes beyond the preference threshold. The multimedia data other than the preference data is added into the data list when the preference weight of the added multimedia data goes beyond or equals to the preference threshold. The preference data is removed from the data list when the preference weight of the removed preference data goes behind the preference threshold.

According to one embodiment of the present invention, the method further comprises sorting the preference data in the data list according to the given preference weights respectively corresponding to the preference data.

According to one embodiment of the present invention, the step of evaluating the user behavior comprises: evaluating the user behavior respectively corresponding to each of the multimedia data in a regular time schedule.

According to one embodiment of the present invention, the multimedia data include audio files, video files, image files or web front-pages.

According to one embodiment of the present invention, the user behavior corresponding to the multimedia data includes a frequency of repeatedly reading through the corresponding multimedia data, a frequency of completely reading through the corresponding multimedia data, a searching action for searching information of the corresponding multimedia data in the internet, a frequency of skipping the corresponding multimedia data or a frequency of interrupting reading the corresponding multimedia data.

The invention also provides an electronic device comprising a storage device and a processor. The storage device has a database storing a plurality of multimedia data and recording a data list listing a plurality of preference data selected from the multimedia data. The processor evaluates a user behavior for respectively reading each of the multimedia data in the database and changes the data list by newly adding one of the multimedia data other than the preference data listed in the data list into the data list when the user behavior corresponding to the newly added multimedia data goes beyond or equals to a preference threshold and removing one of the preference data from the data list when the user behavior corresponding to the removed preference data goes behind the preference threshold.

According to one embodiment of the present invention, the processor changing the data list further comprises: giving a preference weight to each of the multimedia data according to the user behaviors respectively corresponding to the multimedia data, determining whether the preference weight of each of the multimedia data goes beyond the preference threshold, adding the multimedia data other than the preference data into the data list when the preference weight of the added multimedia data goes beyond or equals to the preference threshold and removing the preference data from the data list when the preference weight of the removed preference data goes behind the preference threshold.

According to one embodiment of the present invention, the processor further: sorts the preference data in the data list according to the given preference weights respectively corresponding to the preference data.

According to one embodiment of the present invention, the processor evaluating the user behavior comprises: evaluating the user behavior respectively corresponding to each of the multimedia data in a regular time schedule.

According to one embodiment of the present invention, the multimedia data include audio files, video files, image files or web front-pages.

According to one embodiment of the present invention, the user behavior corresponding to the multimedia data includes a frequency of repeatedly reading through the corresponding multimedia data, a frequency of completely reading through the corresponding multimedia data, a searching action for searching information of the corresponding multimedia data in the internet, a frequency of skipping the corresponding multimedia data or a frequency of interrupting reading the corresponding multimedia data.

In the present invention, the electronic device maintains/builds up the data list listing the preference data based on the user behaviors for reading the multimedia data. More clearly, the data list is dynamically and automatically changed once the pattern of the user behavior for reading the multimedia data is changed. Therefore, the data list meets the current preference of the user for reading the multimedia data and provides the user the most satisfaction entertainment while the user reading the multimedia data according to the data list.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flow chart showing a method for maintaining a data list according to one embodiment of the present invention.

FIG. 2 is a flow chart showing a method for implementing the step S105 of selecting the multimedia data into the preference data list in FIG. 1 according to one embodiment of the present invention.

FIG. 3 is a flow chart showing a method for maintaining a data list according to one embodiment of the present invention.

FIG. 4 is a flow chart showing a method for implementing the step S305 of selecting the multimedia data into the preference data list in FIG. 3 according to one embodiment of the present invention.

FIG. 5 is a schematic diagram showing an electronic device for maintaining the data list according to one embodiment of the present invention.

### DESCRIPTION OF THE PREFERRED EMBODIMENTS

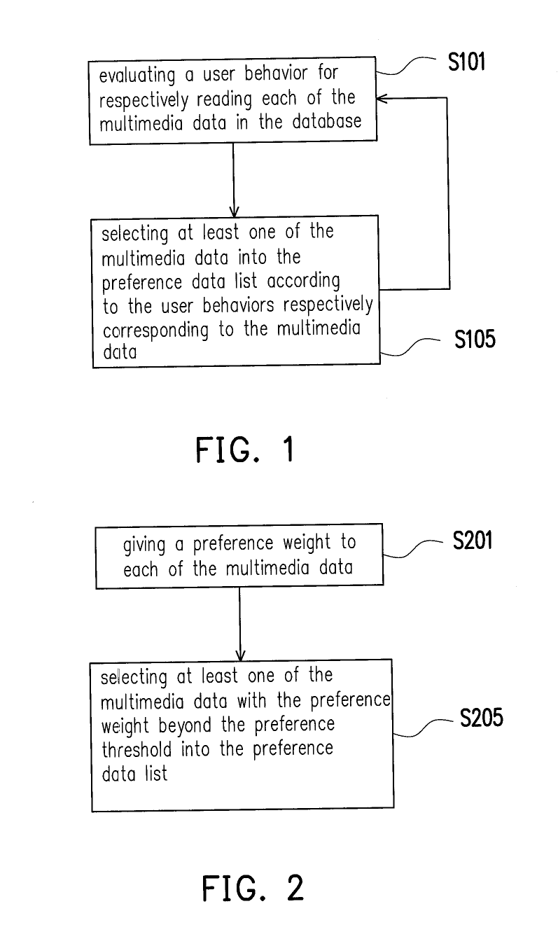

FIG. 1 is a flow chart showing a method for maintaining a data list according to one embodiment of the present invention. In the present embodiment, a data list (also known as a preference data list in the following description) is established and maintained. In the data list, there are at least one multimedia data (also known as the preference data in the following description) which is selected from a plurality of multimedia data stored in the database. It should be noticed that the multimedia data include audio files, video files, image files or web pages (such as web front-pages including news website front-pages, shopping website front-pages, searching engine portal sites, etc.). Also, the data list (i.e. the preference data list) can be, for example, a user favorite playing list for audio files or video files, a user preference photo list for the image files or a bookmark list for the web front-pages.

As shown in FIG. 1, in step S101, a user behavior for respectively reading each of the multimedia data in the database is evaluated. The user behavior for reading a multimedia includes a frequency of repeatedly reading through the corresponding multimedia data, a frequency of completely reading through the corresponding multimedia data, a searching action for searching information of the corresponding multimedia data in the internet, a frequency of skipping the corresponding multimedia data or a frequency of interrupting reading the corresponding multimedia data. For instance, for an audio file (such as a song) as the multimedia data, the user behavior for reading the audio file includes the frequency of repeatedly playing the song, the frequency of completely playing the entire song, the action for searching information (such as the lyrics of the song, the producer of the song, the singer who sings the song, the musician who plays the song, the music video of the song, etc.) of the song in the internet, the frequency of skipping the song without event playing it, the frequency of interrupting playing the song.

In the step S105, at least one of the multimedia data is selected into the preference data list according to the user behaviors respectively corresponding to the multimedia data. Thereafter, the step S101 of evaluating the user behavior respectively corresponding to each of the multimedia data is executed in a regular time schedule. Furthermore, once the step S101 is executed according to the regular time schedule, the step S105 of selecting the multimedia data into the preference data list is executed accordingly.

FIG. 2 is a flow chart showing a method for implementing the step S105 of selecting the multimedia data into the preference data list in FIG. 1 according to one embodiment of the present invention. Noticeably, as shown in FIG. 2, the step S105 of selecting the multimedia data into the preference data list according to the user behavior for reading the corresponding multimedia includes the step S201 of giving a preference weight to each of the multimedia data according to the user behaviors respectively corresponding to the multimedia data. For instance, when the frequency of repeatedly/completely reading a multimedia data is relatively high (e.g. higher than the average frequency of repeatedly/completely reading each of the multimedia data), it is determined that the user shows preference for the multimedia data. Hence, the preference weight given to the corresponding multimedia data is relatively large. Further, when the frequency of skipping the multimedia data is relatively high (e.g. higher than the average frequency of skipping each of the multimedia data), it is determined that the user shows no preference for the multimedia. Therefore, the preference weight given to the corresponding multimedia data is relatively small. Furthermore, in one embodiment, different kinds of user behaviors are given different weight percentages. There may be more than one user behavior expressed in reading one multimedia data. For reading a particular multimedia data, the preference weight of the corresponding particular multimedia data is calculated by summing the weight percentages of user behaviors. That is, in one embodiment, the preference weight given to the particular multimedia data is corresponding to the combination of the user behaviors for reading the corresponding particular multimedia data.

Moreover, as shown in FIG. 2, in the step S205, at least one of the multimedia data is selected into the preference data list. It should be noticed that the preference weight of each of the selected multimedia data in the preference data list goes beyond or equals to a preference threshold. In other words, when the preference weight of the multimedia data is larger than or equal to the preference threshold, the multimedia data is selected/added into the preference data list.

In the aforementioned embodiments, the methods according to the present invention can be used to consider whether a new multimedia data can be added into an already existed data list when the new multimedia data is stored into the database or to build up a preference data list according to the recorded user behaviors for respectively reading the multimedia data in the database. Furthermore, the methods according to the present invention also can be used to maintain an already existed preference data list and to update the preference data list in a regular time schedule. In other words, the application of the method according to the present invention is not limited thereto.

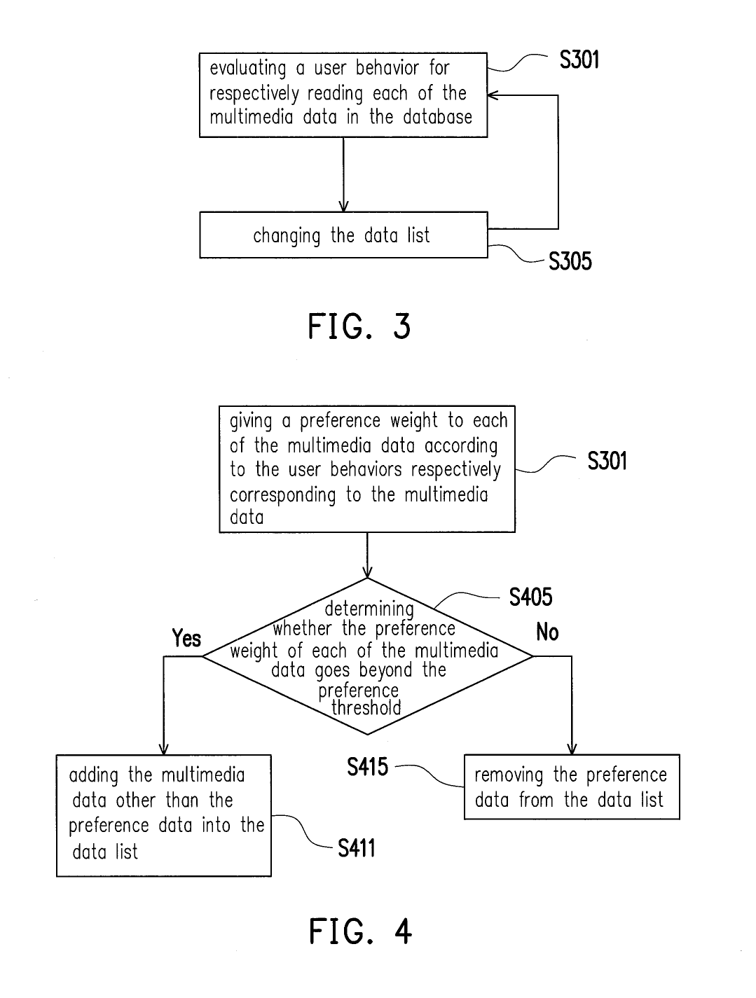

In the following paragraphs, an embodiment of the present invention is described accompanied with drawings and provides another scope of the present invention. FIG. 3 is a flow chart showing a method for maintaining a data list according to one embodiment of the present invention. As shown in FIG. 3, in the step S301, a user behavior for respectively reading each of the multimedia data in the database is evaluated. In the step S305, the data list is changed. That is, the data list is changed by newly adding one of the multimedia data other than the preference data listed in the data list into the data list when the user behavior corresponding to the newly selected multimedia data goes beyond or equals to a preference threshold. More clearly, the user behavior is quantified to be corresponding to some kind of indication such as the weight value. That is, when the weight value corresponding to the user behavior is larger than or equal to the preference threshold, the multimedia data corresponding to the user behavior is added into the data list. Furthermore, also in the step S305, the data list is changed by removing one of the preference data from the data list when the user behavior corresponding to the removed preference data goes behind the preference threshold. More clearly, when the weight value corresponding to the user behavior is smaller than the preference threshold, the preference data corresponding to the user behavior is removed from the data list.

Thereafter, the step S301 of evaluating the user behavior respectively corresponding to each of the multimedia data is executed in a regular time schedule. Furthermore, once the step S301 is executed according to the regular time schedule, the step S305 of changing the preference data list is executed accordingly.

FIG. 4 is a flow chart showing a method for implementing the step S305 of selecting the multimedia data into the preference data list in FIG. 3 according to one embodiment of the present invention. More specifically, as shown in FIG. 4, the step S305 of changing the data list comprises the step S401 of giving a preference weight to each of the multimedia data according to the user behaviors respectively corresponding to the multimedia data. It should be noticed that, in one embodiment, different kinds of user behaviors are given different weight percentages. There may be more than one user behavior expressed in reading one multimedia data. For reading a particular multimedia data, the preference weight of the corresponding particular multimedia data is calculated by summing the weight percentages of user behaviors. That is, in one embodiment, the preference weight given to the particular multimedia data is corresponding to the combination of the user behaviors for reading the corresponding particular multimedia data.

In the step S405, it is determined whether the preference weight of each of the multimedia data goes beyond the preference threshold. When the preference weight of the multimedia data other than the preference data in the data list goes beyond or equals to the preference threshold, the multimedia data other than the preference data is added into the data list (step S411) such that the data list is changed. Alternatively, when the preference weight of the preference data in the data list goes behind the preference threshold, the preference data is removed from the data list (step S415) such that the data list is changed.

In one embodiment, in the data list (i.e. the preference data list), the multimedia data (i.e. the preference data) are sorted according to the given preference weights respectively corresponding to the multimedia data. That is, when being read, the multimedia data in the data list can be continuously read according to the sorting order.

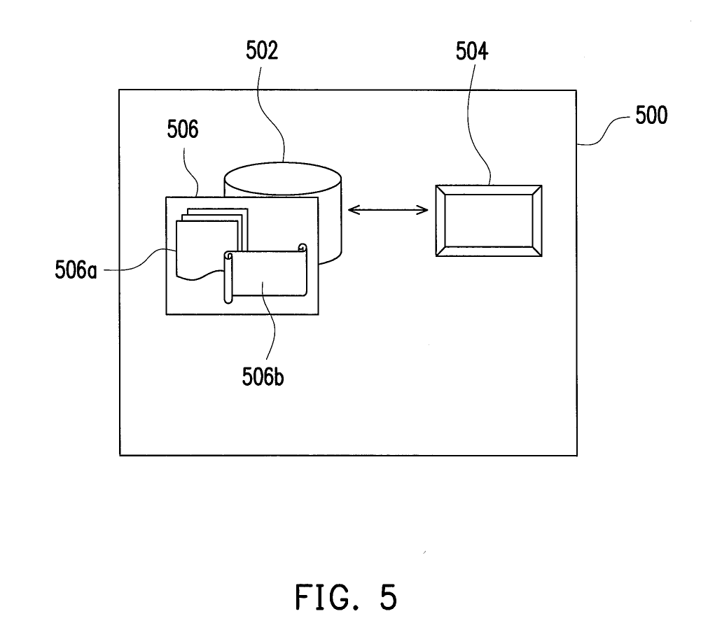

FIG. 5 is a schematic diagram showing an electronic device for maintaining the data list according to one embodiment of the present invention. As shown in FIG. 5, the electronic device 500 of the present embodiment has a storage device 502 and a processor 504. The electronic device 500 can be, for example, a mobile phone, a smart phone, a digital camera, a laptop, a desktop or any electronic device capable of reading multimedia data. The storage device 502 can be, for example, an optical disc, a hard disk, a portable hard disk or any storage medium capable of storing data. The processor 504 can be, for example, a central processing unit, a micro processor or a micro controller. The storage device 502 has a database 506 storing a plurality of multimedia data 506a and recording a data list 506b listing a plurality of preference data selected from the multimedia data 506a. Furthermore, the database 506 also records the user behaviors (not shown) respectively corresponding to the multimedia data. That is, the electronic device (i.e. the processor) keeps on tracking the user behaviors while the electronic device reads the multimedia data respectively.

The processor 504 evaluates the user behavior for respectively reading each of the multimedia data in the database and changes the data list according to the corresponding user behaviors. That is, the processor 504 implements the steps shown in the aforementioned embodiments (including the steps S101˜S105, S201˜S205, S301˜S305 and S401˜S415). The steps S101˜S105, S201˜S205, S301˜S305 and S401˜S415 and the terms in used are detailed and defined in the previous embodiments and are not further described herein.

In the present invention, the electronic device maintains/builds up the data list listing the preference data based on the user behaviors for reading the multimedia data. More clearly, the data list is dynamically and automatically changed once the pattern of the user behavior for reading the multimedia data is changed. Therefore, the data list meets the current preference of the user for reading the multimedia data and provides the user the most satisfaction entertainment while the user reading the multimedia data according to the data list.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. A method for selecting at least one of a plurality of multimedia data into a preference data list, the method comprising:
evaluating a user behavior for the multimedia data respectively;
giving a weight to each of the multimedia data according to the user behaviors; and
selecting at least one of the multimedia data into the preference data list according to the user behaviors respectively corresponding to the multimedia data.

2. The method of claim 1, wherein the step of selecting at least one of the multimedia data into the preference data list comprises:
selecting at least one of the multimedia data into the preference data list, wherein the preference weight of each of the selected multimedia data in the preference data list goes beyond a preference threshold.

3. The method of claim 2, further comprising:
sorting the selected multimedia data in the preference data list according to the given preference weights respectively corresponding to the selected multimedia data.

4. The method of claim 1, wherein the step of evaluating the user behavior for respectively reading each of the multimedia data comprises:
evaluating the user behavior respectively corresponding to each of the multimedia data in a regular time schedule.

5. The method of claim 1, wherein the multimedia data include audio files, video files, image files or web front-pages.

6. The method of claim 1, wherein the user behavior corresponding to the multimedia data includes a frequency of repeatedly reading through the corresponding multimedia data, a frequency of completely reading through the corresponding multimedia data, a searching action for searching information of the corresponding multimedia data in the internet, a frequency of skipping the corresponding multimedia data or a frequency of interrupting reading the corresponding multimedia data.

7. A method for maintaining a data list listing a plurality of preference data selected from a plurality of multimedia data in a database, the method comprising:
evaluating a user behavior for respectively reading each of the multimedia data in the database; and
changing the data list by newly adding one of the multimedia data other than the preference data listed in the data list into the data list when the user behavior corresponding to the newly added multimedia data goes beyond or equals to a preference threshold and removing one of the preference data from the data list when the user behavior corresponding to the removed preference data goes behind the preference threshold.

8. The method of claim 7, wherein the step of changing the data list comprises:
giving a preference weight to each of the multimedia data according to the user behaviors respectively corresponding to the multimedia data;
determining whether the preference weight of each of the multimedia data goes beyond the preference threshold;
adding the multimedia data other than the preference data into the data list when the preference weight of the added multimedia data goes beyond or equals to the preference threshold; and
removing the preference data from the data list when the preference weight of the removed preference data goes behind the preference threshold.

9. The method of claim 8, further comprising:
sorting the preference data in the data list according to the given preference weights respectively corresponding to the preference data.

10. The method of claim 7, wherein the step of evaluating the user behavior comprises:
evaluating the user behavior respectively corresponding to each of the multimedia data in a regular time schedule.

11. The method of claim 7, wherein the multimedia data include audio files, video files, image files or web front-pages.

12. The method of claim 7, wherein the user behavior corresponding to the multimedia data includes a frequency of repeatedly reading through the corresponding multimedia data, a frequency of completely reading through the corresponding multimedia data, a searching action for searching information of the corresponding multimedia data in the internet, a frequency of skipping the corresponding multimedia data or a frequency of interrupting reading the corresponding multimedia data.

13. An electronic device, comprising:
a storage device, having a database storing a plurality of multimedia data and recording a data list listing a plurality of preference data selected from the multimedia data; and
a processor, evaluating a user behavior for respectively reading each of the multimedia data in the database and changing the data list by newly adding one of the multimedia data other than the preference data listed in the data list into the data list when the user behavior corresponding to the newly added multimedia data goes beyond or equals to a preference threshold and removing one of the preference data from the data list when the user behavior corresponding to the removed preference data goes behind the preference threshold.

14. The electronic device of claim 13, wherein the processor changing the data list further comprises:
giving a preference weight to each of the multimedia data according to the user behaviors respectively corresponding to the multimedia data;
determining whether the preference weight of each of the multimedia data goes beyond the preference threshold;
adding the multimedia data other than the preference data into the data list when the preference weight of the added multimedia data goes beyond or equals to the preference threshold; and
removing the preference data from the data list when the preference weight of the removed preference data goes behind the preference threshold.

15. The electronic device of claim 14, wherein the processor further: sorts the preference data in the data list according to the given preference weights respectively corresponding to the preference data.

16. The electronic device of claim 13, wherein the processor evaluating the user behavior comprises:
evaluating the user behavior respectively corresponding to each of the multimedia data in a regular time schedule.

17. The electronic device of claim 13, wherein the multimedia data include audio files, video files, image files or web front-pages.

18. The electronic device of claim 13, wherein the user behavior corresponding to the multimedia data includes a frequency of repeatedly reading through the corresponding multimedia data, a frequency of completely reading through the corresponding multimedia data, a searching action for searching information of the corresponding multimedia data in the internet, a frequency of skipping the corresponding multimedia data or a frequency of interrupting reading the corresponding multimedia data.
